(19) United States
(12) Patent Application Publication
(10) Pub. No.: US 2007/0191978 A1
(43) Pub. Date: Aug. 16, 2007

(54) Method and apparatus for positioning playback of MP3 file in MP3-enabled mobile phone

(75) Inventor: Yong-Goo Chung, Gum-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Smasung Electronics Co., Ltd.

(21) Appl. No.: 11/649,863

(22) Filed: Jan. 5, 2007

(30) Foreign Application Priority Data
Feb. 13, 2006 (KR) 2006-0013564

(51) Int. Cl. G06F 17/00

(52) U.S. Cl. 700/94

(57) ABSTRACT

A playback positioning method and apparatus are provided. A determination is made as to whether a position selection mode is activated and a music file is selected from a music files list if the position selection mode is activated. The music file is partitioned into a plurality of segments which have identical percentages. The segments are mapped to reference keys, respectively and a progress status of the music file is displayed. Playback is positioned at a segment corresponding to the key input, while the music file is played. The quick selection of a playback position regardless of the length of the MP3 file is facilitated.

### CROSS REFERENCE TO RELATED APPLICATIONS

This application claims the benefit under 35 U.S.C. § 119(a) of a Korean Patent Application, Serial No. 2006-0013564, filed in the Korean Intellectual Property Office on Feb. 13, 2006, the entire contents of which is hereby incorporated by reference.

### BACKGROUND OF THE INVENTION

1. Field of the Invention

The present invention relates to a mobile phone comprising an MPEG-1 layer 3 (MP3) play function. More particularly, the present invention relates to a playback positioning method for an MP3 file in an MP3-enabled mobile phone, which is capable of quickly selecting a playback position regardless of the length of the MP3 file by partitioning the MP3 file into a plurality of segments in an identical percentage and by mapping the segments to respective number keys.

2. Background of the Related Art

In recent years, mobile phones equipped with MP3 play modules have been widely used. These types of mobile phones are capable of searching start points of mp3 files, and moving the playback position by pushing fast forward or rewind keys while they are being played. Finding an accurate playback position will take a long time when the fast forward or rewind keys are used to find a playback position. This is especially true when the MP3 song is long.

Using a software MP3 player, such as Winamp, to play an MP3 song, makes it possible to change the playback position by positioning a pointer on a progress bar using a mouse. This facilitates the finding of the user's intended playback position without any inconvenience caused by having to push the manipulation key for a long time. Such software-based playback positioning may be appropriate for a personal digital assistant (PDA) device comprising a wide display and pencil input mechanism. However, the mobile phone is limited to the use of such software based playback positioning since it is difficult to adopt the pencil input mechanism due to the small display screen, resulting in use of an inconvenient key manipulation-based positioning method.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a playback positioning method for an MP3-enabled mobile phone, which is capable of expediting playback positioning.

Another object of an exemplary embodiment of the present invention is to provide a playback positioning method for an MP3-enabled mobile phone, which is capable of increasing a user's convenience by allowing the user to find an accurate playback position with simplified key manipulation.

In order to achieve the above and other objects, the playback positioning method for an electric music file player, according to an exemplary embodiment of the present invention, is used. A determination is made as to whether a position selection mode is activated and a music file is selected from the music files list if the position selection mode is activated. The music file is partitioned into a plurality of segments with identical percentages, which are mapped to reference keys, respectively. Progress status of the music file is displayed and playback is positioned at a segment corresponding to a key input, while the music file is played.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a block diagram illustrating a mobile phone according to an exemplary embodiment of the present invention;

FIG. 2 is a flowchart explaining the playback positioning method according to an exemplary embodiment of the present invention; and

FIG. 3 is a drawing explaining how an MP3 file is partitioned according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

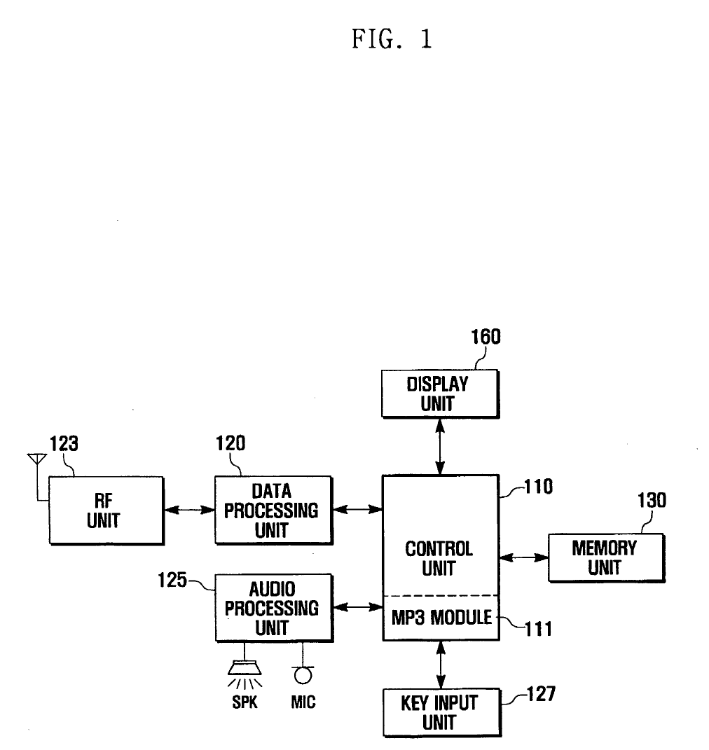

FIG. 1 is a block diagram illustrating a mobile phone according to an exemplary embodiment of the present invention. As shown in FIG. 1, the mobile phone comprises a radio frequency (RF) unit 123, a data processing unit 120, an audio processing unit 125, a memory unit 130, a control unit 110, a MP3 module 111, a display unit 160, and a key input unit 127.

The RF unit 123 performs communication functions of the mobile terminal and comprises an RF transmitter for up-converting and amplifying the signal to be transmitted and a RF receiver for low noise-amplifying and down-converting the received signal.

The data processing unit 120 comprises a transmitter for encoding and modulating the signal to be transmitted and a receiver for demodulating and decoding the received signal. For example, the data processing unit 123 is provided with a modem and a codec pack. The codec pack comprises a data codec for processing the data packet and an audio codec for processing an audio signal such as voice.

The audio processing unit 125 replays MP3 files and audio signals output from the control unit 110 or transmits the audio signals input through a microphone to the audio codec of the data processing unit 120.

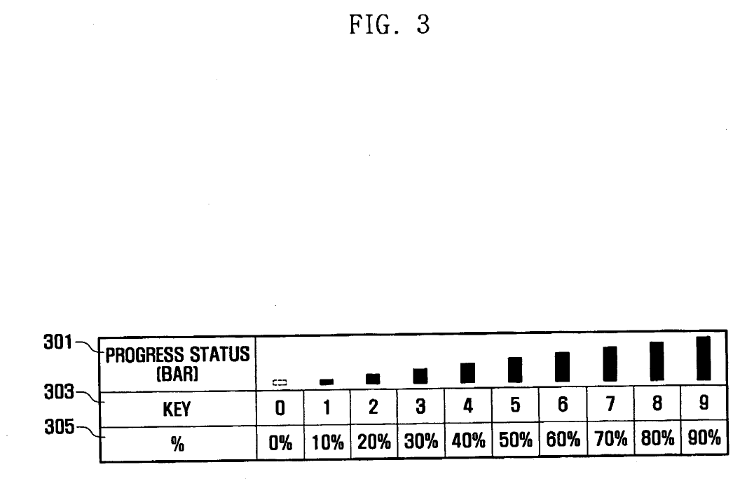

The memory unit 130 comprises a program memory and a data memory. The program memory stores the programs for controlling the typical operation of the mobile terminal and the programs for inputting a reception number and transmitting the written message. Also, the data memory may temporarily store the data generated while the programs are operating. In an exemplary embodiment of the present invention, the program memory stores the playback positioning program for moving a pointer to a segment of the MP3 while playing it. Once an MP3 file is selected to be played, the playback positioning program divides the MP3 file into 10 segments and designates the 10 segments to the respective number keys of 0 to 9. In this case, each segment occurs 10% of the entire length of the MP3 file as shown at 305 of FIG. 3. The division scale can be changed such that the MP3 file can be divided into 20, 30, or more. Also, the MP3 file can be divided in a unit of a specific percentage such that the MP3 file is divided and played back by 1% if a number key of “1” is input.

The control unit 110 controls the overall operations of the mobile terminal. In this exemplary embodiment of the present invention, the MP3 module 111 is integrated into the control unit 110, however, it is not limited to a built-in module. According to an exemplary implementation, the MP3 module 111 may also be installed as a detachable module.

Once a position selection is instructed while the MP3 module 111 is in a playback mode, the titles of the perspective MP3 songs are displayed on the display unit 160 to facilitate the selection of one of the MP3 songs. If an MP3 file is selected, the selected MP3 file is divided into 10 segments which are all identical in size. That is, each segment represents 10% of the MP3 file. If a number key input occurs while the selected MP3 file is played, the MP3 module 111 replays the MP3 file from the segment corresponding to the number key.

The display unit 160 displays the user information output from the control unit 110. The display unit 160 can be a liquid crystal display (LCD). In this case the display unit 160 can be provided with a LCD controller and a memory for storing the video data and an LCD device. If the LCD is implemented with a touch screen mechanism, the display unit 160 may be used as an input device.

The key input unit 127 is provided with a plurality of keys for inputting various numbers and characters and for configuring various functions. The number keys, corresponding to the numbers 0 to 9 as shown at 303 in FIG. 3, of the key input unit 127 are designated for the segments generated by dividing a selected MP3.

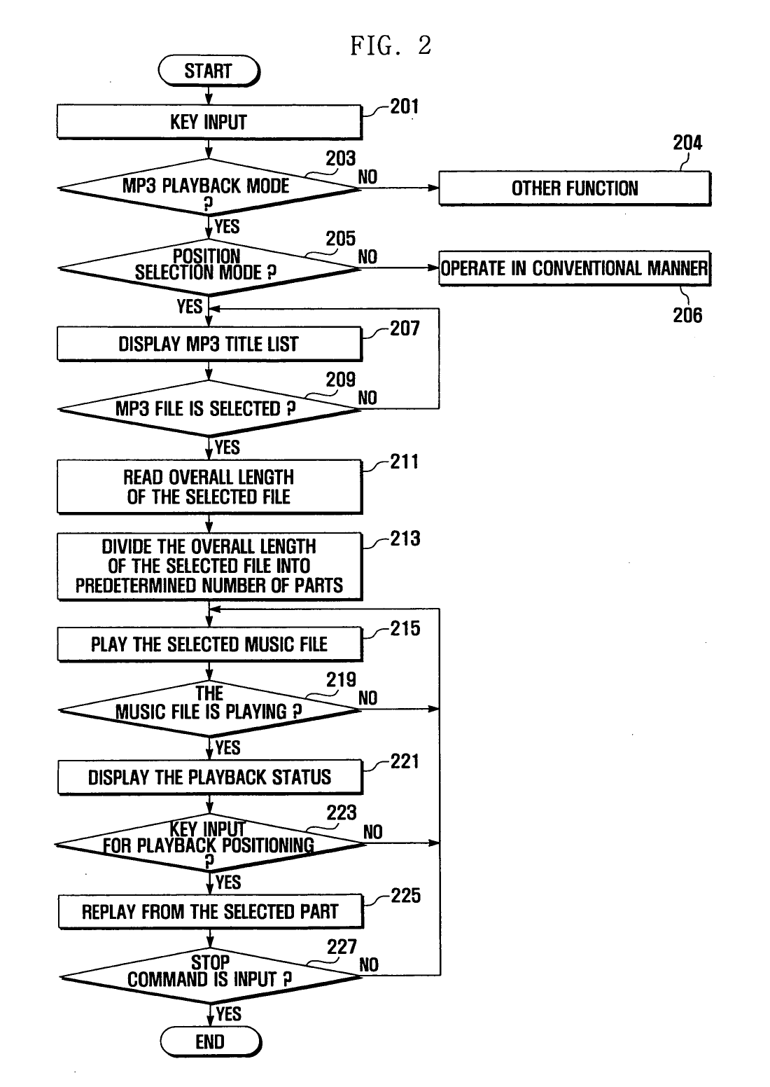

FIG. 2 is a flowchart explaining the playback positioning method according to an exemplary embodiment of the present invention.

Referring to FIG. 2, once there is a key input for playback positioning through the key input unit 127 at step 201, the control unit 110 determines whether the mobile phone is in the MP3 play mode at step 203. If it is determined that the mobile phone is not in the MP3 play mode, the present mode is maintained. If the mobile terminal is in the MP3 play mode, the control unit 110 determines whether the position selection mode is activated for the number key input at step 205. If the position selection mode is not activated, the control unit 110 controls in a conventional manner at step 206 such that the playback position moves forward or backward during the time period in which the fast forward or rewind key is pushed.

Alternatively, if the position selection mode is activated, the control unit 110 controls the display unit 160 to display the titles of the MP3 files at step 207 and determines whether there is an input for selecting one of the MP3 files at step 209. If an MP3 file is selected, the control unit 110 reads the overall length of the selected MP3 file at step 211 and divides the overall length of the MP3 files into 10 segments of regular percentages in step 213. The segments are mapped to the number keys of 0 to 9. The number of segments can be 20, 30, or more. Also, the MP3 file can be divided into percentages such that the MP3 file is divided and played back by 1% if a number key of “1” is input.

Subsequently, the control unit 110 controls the MP3 module 111 to play the selected MP3 at step 215. The control unit 110 determines whether the selected MP3 file is played at step 219 and controls the display unit 160 to display the playback status of the MP3 file at step 221 if the selected file is normally played as shown at 301 in FIG. 3.

While the MP3 file is played, the controller 110 determines whether there is a key input for the play back positioning at step 223. If a number key is input, the control unit 110 moves the playback position to the segment of the MP3 corresponding to the pushed number key and replays the MP3 file form the selected segment at step 225.

For example, if the number key of 5 is pushed as shown in FIG. 3 at step 223, the control unit 110 restarts playing the MP3 file from the position corresponding to the 50% segment of the MP3 file. Also, the number key of 3 is input, the MP3 file is replayed form the 30% segment of the MP3 file. In this exemplary embodiment of the present invention, the MP3 file is divided into 10 playback segments which are divided into in units of 10 percent. However, the MP3 file can be further segmented to 20 or 30 segments. In this case, the playback segment selection can be carried out by combination of two number keys. Also, the playback segment can be determined by the value input through at least one key such that the playback segment of the length corresponding to the input value is played back.

If a stop command is input by the user's key manipulation at step 227, the control nit 110 stops playing the MP3 file.

While the present invention has been shown and described with reference to certain exemplary embodiments, thereof, it will be understood by those skilled in the art that various changes in form and details may be made therein without departing from the spirit and scope of the invention as defined by the appended claims and their equivalents.

As described above, the playback positioning method of an exemplary embodiment of the present invention partitions the play length of an MP3 file into a predetermined number of segments in an identical percentage and maps the segments to predetermined keys such that it is possible to quickly select a playback position regardless of the length of the MP3 file.

What is claimed is:

1. A playback positioning method for electric music file player, comprising:
partitioning a music file read from a storage into a plurality of segments; and
positioning playback at one of the segments, selected by a key input.

2. The method of claim 1, wherein the music file is at least partitioned into a specific percentage and a number of segments to be partitioned are input and the segments of the music file are mapped to reference number keys, respectively.

3. The method of claim 1 further comprising setting a position selection mode for setting a number of segments and links between the segments and keys.

4. The method of claim 1 further comprising displaying progress status of the music file.

5. A playback positioning method for an electric music file player, comprising:
determining whether a position selection mode is activated;
selecting a music file from music files list if the position selection mode is activated;
partitioning the music file into a plurality segments in an identical percentage, wherein the segments are mapped to reference keys, respectively;
displaying a progress status of the music file;
positioning playback at a segment corresponding to a key input, while the music file is played.

6. A playback positioning apparatus for an electric music file player, comprising:
a configuration unit for setting a position selection mode;
a display unit for displaying music files to be selected;
a partition unit for partitioning a selected music file into a plurality segments in an identical percentage and for mapping the segments to reference keys, respectively;
a music file play unit for playing music files and for positioning playback at a segment corresponding to a key input, while the music file is played.

7. A mobile communication terminal comprising:
a control unit for controlling operations of the mobile communication terminal;
a display unit for displaying titles of perspective MPEG-1 layer 3 (MP3) songs;
a radio frequency (RF) unit for performing communication functions of the mobile terminal;
a data processing unit for encoding and modulating a signal to be transmitted and for demodulating and decoding a received signal;
an audio processing unit for replaying MP3 files and audio signals output from the control unit;
a key input unit for inputting various numbers and characters and for configuring various functions; and
a memory unit.
